(19) United States
(12) Patent Application Publication
(10) Pub. No.: US 2011/0262019 A1
(43) Pub. Date: Oct. 27, 2011

(54) System for Enhancing Comparative Grayscalized and Colorized Medical Images

(75) Inventors: Ein-Yiao Shen, Taipei City (TW); Gen-Jia Li, Taipei City (TW)

(73) Assignee: CHIN-YUEH CO., LTD., Taipei City (TW)

(21) Appl. No.: 12/888,683

(22) Filed: Sep. 23, 2010

(30) Foreign Application Priority Data
Apr. 27, 2010 (TW) 099113256

(51) Int. Cl. G06T 7/00

(52) U.S. Cl. 382/131

(57) ABSTRACT

The present invention relates to a system for enhancing comparative and colorized medical images, comprising: a device for importing images, transmits grayscale images from scanners, X-ray film or files; and a device for processing images, transforms grayscale images into compared color images.

### FIELD OF THE INVENTION

The present invention is related to a system for enhancing comparative grayscalized and colorized medical images.

### BACKGROUND OF THE INVENTION

Grayscale image has been used for lots of technical image display, such as satellite image, medical X-ray image, electron microscopic image and etc. These images are usually displayed as grayscale due to imaging principle limitation. Because eye ball's physiology prefers comparative color image recognition over black/white images, colored image will facilitate recognition level as well as provide more detail information.

Colorization of grayscale image is a very hot area. Information of grayscale image is reduced to one dimension (grayscale value), and colorization is to use this information to trace back the conditions of RGB three dimensions. It is common to see one grayscale value against multiple color values during transformation process which means one grayscale value can reflect multiple color values. Therefore grayscale image colorization does not have one absolute solution.

### SUMMARY OF THE INVENTION

The present invention relates to a system for enhancing comparative grayscalized and colorized medical images, comprising: a device for importing images, transmits grayscale images from scanners, X-ray film or files; and a device for processing images, transforms grayscale images into compared color images.

### BRIEF DESCRIPTION OF THE DRAWINGS

FIG. 1 shows an operation flow chart of the present invention.

FIG. 2 shows an example of the present invention.

FIG. 3 shows dissecting images of three primary colors of the present invention.

FIG. 4 shows comparative colorized images of the present invention.

FIG. 5 shows enhanced comparative colorized images of the present invention.

FIG. 6 shows exemplary images of the present invention.

FIG. 7 shows images of partial enlargement for users.

### DETAILED DESCRIPTION OF THE INVENTION

The present invention relates to a method of image lightness grayscalization (256 scales˜4096 scales) used to enhance contrast of various parts of image. By enhancement of lightness, colorfulness or hue difference, this method transforms black/white medical image into grayscale, digital and colorized images to increase the sensitivity of medical examiners and improve the efficiency, effectiveness and accuracy of image interpretation.

One prior art is related to a method using two layer zone extraction and background color confirmation to generate document binary image (Taiwan R.O.C. Pat. NO. 366476), which does not provide immediate black/white image colorization technology. The second prior art is a image quality testing method (Taiwan R.O.C. Pat. NO. 1280516) which is not a black/white image colorization display technology. The present invention which provides black/white medical image colorization method has not been found to date.

The characteristics of the present invention focused on transforming black/white medical image into grayscale, digital and colorized high quality medical image which is helpful for clinical interpretation. The inventor of the present invention and people skilled in art are focused on finding better and faster image display methods by shortening image colorization process.

The present invention is related to a system for enhancing comparative grayscalized and colorized medical images including a medical image input processing device, which can obtain grayscale image by scanning or file transferring and enhances comparativeness and grayscale, and a medical image processing device, which can transform grayscale image file (ultra sound image, X-ray file, blood vessel image, endoscopic image, CT or MRI) into comparative color image file.

The present invention is also accompanied with an image output device which can export file, print picture or display comparative color image. The present invention also adds random access memory for storage usage. The image output device also provides user operation interface by touch mode or button operation to set display parameter (such as grayscale range) or mode switch (such as color mode) to help user define ranges or set color transformation parameters. Adjusting parameter setting for enlargement of certain area or enhancement of color, lightness or colorfulness difference can be useful for users for further differential diagnosis. The present invention can also combine with PACS to facilitate image storage.

The present invention of transforming grayscale image into comparative color image includes the following steps: enhancing lightness of black/white medical image, expressing lightness difference by 2⁸ (256) to 2¹² (4096) steps of gray scale, and showing different grayscale variation with color or colorfulness via parameter setting.

The present invention provides a colorization technology of black/white medical image which is convenient for image interpretation of medical or research institutions with great market potential.

The present invention can also measure relative grayscale of target by wand or cursor indicator. It can also display target image analysis with selected grayscale value manually, semi-automatically or automatically to further calculate the image area or volume of said target.

### EXAMPLES

Enhance lightness of obtained black/white medical image and transform the difference of lightness into 2⁸ (256) to 2¹² (4096) gray scale by computers.

The grayscale value of indicating target can be determined with a wand or cursor indicator by operators. Depending on the difference of colorization or colorfulness via grayscale data algorithm, it can facilitate image interpretation.

This technology can be widely used in current or future black/white medical image including ultrasound, X-ray, angiography, endoscopic image, CT or MRI.

The desired region of the image can be circled. Enhancing the lightness contrast of region of interest (ROI) can show different grayscale variation by color or colorfulness. The difference of image grayscale can be expressed by various colors, lightness or colorfulness to facilitate differential diagnosis. For example, in a 1024 scales image, it can evenly display 0˜1024 by red, orange, yellow, green, blue, indigo and violet. It can also show only the difference of 100˜200 by colorfulness such as extreme dark red, dark red, light red and pink.

The present invention transforms grayscale mode into color mode according to the following algorithm:

1. set threshold of Aₘᵢₙ and Aₘₐₓ, select grayscale range for colorization;
2. according to image maximal and minimal value, divide image grayscale value into N;
3. label HSVA (Hue, Saturation, Lightness, Alpha) to recalculated N grayscales;
4. adjust H for hue of display to determine color;
5. remove Aₘᵢₙ and Aₘₐₓ grayscale from the original image, and transform it into color image of step 2˜step 4; or
6. set alpha of color image from step 2˜step 4 as 0.5, and overlay it with the original image.

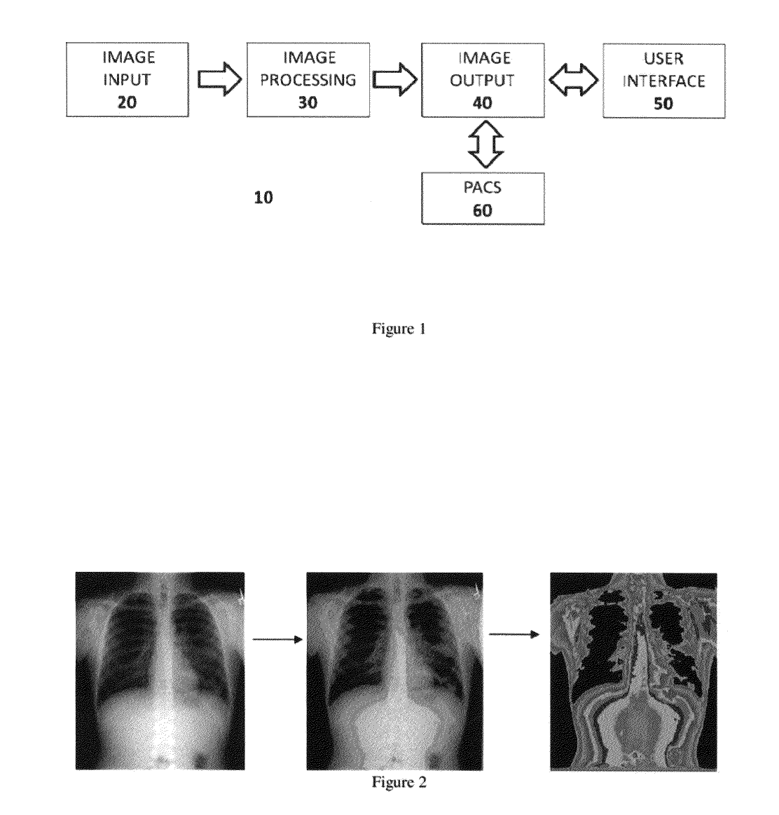

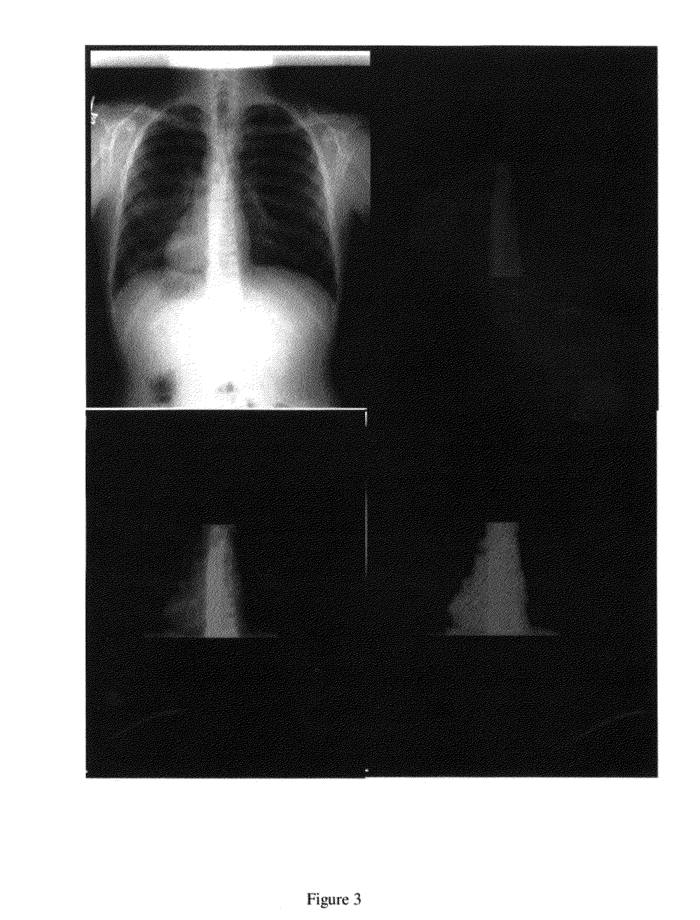

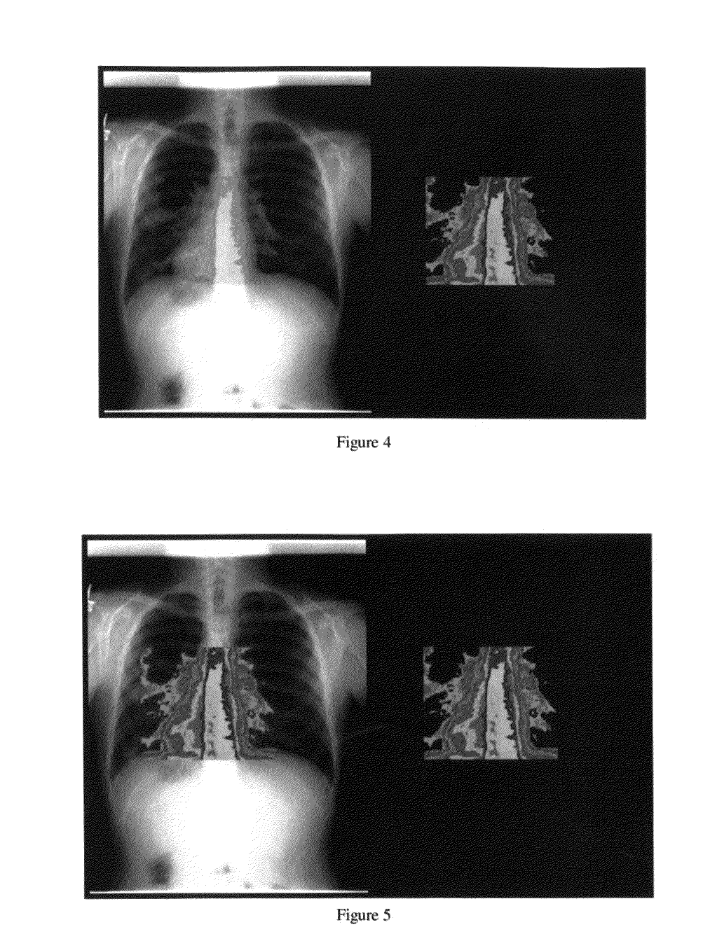

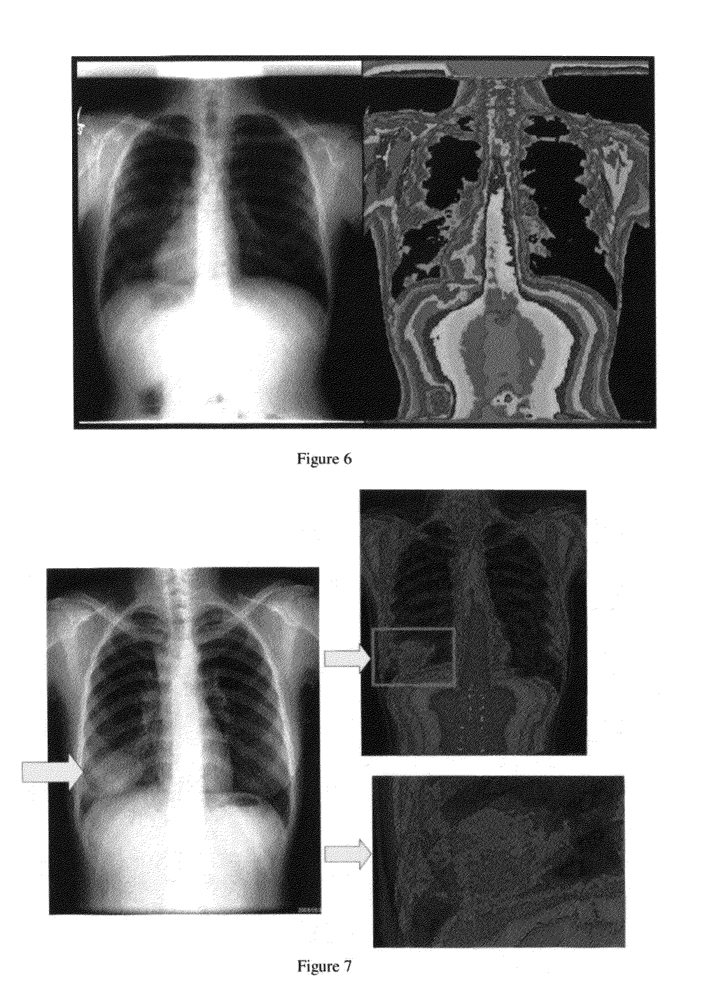

The present invention is transforming black/white medical image into grayscale, digital, and colorized images. FIG. 1 is the operation flow chart of the present invention 10 where image input device 20 obtains grayscale image (from ultrasound image, X-ray film, blood vessel image, endoscopic image, CT or MRI), transforms it into color image by image processing device 30, exports file or displays it on multimedia via image output device 40, parameter setting, mode switch or image zoom in/out can be controlled by touch mode or button operation through user interface 50. Besides, the present invention can connect and integrate to PACS 60 in hospital. FIG. 2 is the flow chart of the present invention which transforms grayscale image into color image, and adjust colorfulness, lightness or contrast based on user request. FIG. 3 shows the dissecting images of three primary colors of the present invention which can be assembled into comparative color image as shown in FIG. 4, and further enhanced colorfulness, lightness, or contrast as shown in FIG. 5. FIG. 6 shows exemplary images of the present invention. FIG. 7 shows images of partial enlargement for users.

### REFERENCE NUMERALS

10 The system of present invention
20 Image input device
30 Image processing device
40 Image output device
50 User interface
60 PACS

What is claimed is:

1. A system for enhancing comparative grayscalized and colorized medical images which comprises:
a medical image input processing device which obtains grayscale image by scanning or file transferring and enhances the image comparativeness and grayscale; and
a medical image processing device which transforms grayscale image file into comparative color image file.

2. The system of claim 1, which further comprises a medical image output device to export or display comparative colorized image file on multimedia.

3. The system of claim 1, wherein the system also includes random access memory for storage usage.

4. The system of claim 1, which follows steps including obtaining image, enhancing black/white medical image lightness, expressing lightness difference by 2⁸ (256) to 2¹² (4096) grayscales, and showing different grayscale variation with color or colorfulness via parameter setting to transform grayscale image files into comparative color image files.

5. The system of claim 1, wherein said grayscale image file includes ultrasound image, X-ray film, blood vessel image, endoscopic image, computer tomography, magnetic resonance imaging (MRI), positron emission tomography (PET), pathological section or staining section.

6. The system of claim 1, which is combined with medical image storage system.

7. The system of claim 2, wherein said image output device further provides user operation interface.

8. The system of claim 7, wherein said user operation interface is operated via touch mode or button operation.

9. The system of claim 7, wherein said user operation interface includes display parameter setting or mode switch.

10. The system of claim 9, wherein said display parameter is in grayscale range.

11. The system of claim 9, wherein said mode switch is color mode.

12. The system of claim 7, wherein users set range or color transformation parameters with said user operation interface.

13. The system of claim 12, wherein said range comprises enlargement, or enhancement variation of color, lightness or colorfulness.

14. The system of claim 13, wherein said variation is useful for differential diagnosis by users.

15. The system of claim 1, which uses a wand or cursor indicator to measure relative grayscale value of target.

16. The system of claim 1, which displays target image analysis with selected grayscale value manually, semi-automatically or automatically.

17. The system of claim 1, which calculates image area or volume of target with selected grayscale value manually, semi-automatically or automatically.
